(19) United States
(12) Patent Application Publication
(10) Pub. No.: US 2023/0397048 A1
(43) Pub. Date: Dec. 7, 2023

(54) SYSTEM AND METHODS FOR 5G AND WLAN PRIVATE NETWORK CONVERGENCE FOR IMPROVED QOS AND QOE

(71) Applicant: EdgeQ, Inc., Santa Clara, CA (US)

(72) Inventors: Gururaj PADAKI, Bangalore (IN); Sriram RAJAGOPAL, Karnataka (IN); Haripriya SURAMPUDI, Bengaluru (IN); Hersh Vardhan SHUKLA, Bangalore (IN); Venkatesh SUKUMARAN, Chennai (IN)

(73) Assignee: EdgeQ, Inc., Santa Clara, CA (US)

(21) Appl. No.: 17/832,593

(22) Filed: Jun. 4, 2022

(51) Int. Cl. H04W 28/08; H04W 28/02

(52) U.S. Cl. CPC H04W 28/0983; H04W 28/0268; H04W 84/12

(57) ABSTRACT

Described in the present disclosure are system and method embodiments for 5G and WLAN private network convergence to improve Quality of service (QoS) and Quality of experience (QoE) by switching, steering or splitting the traffic using a cognitive layer. The Cognitive layer may sense signal conditions and learn user preferences for traffic allocation between available Wi-Fi and 5G networks. In embodiments, the cognitive layer may comprise an Artificial Intelligence (AI) or Machine Learning (ML) module, signal conditions sensor, and user QoS/QoE aware schedulers. A cloud-based service controller may be incorporated to make decisions on user QoS and QoE allocation based on the cognitive layer input. Implementation of the network convergence embodiments may improve QoS/QoE.

### TECHNICAL FIELD

The present disclosure relates generally to systems and methods for wireless network convergence. More particularly, the present disclosure relates to systems and methods for 5G and WLAN private network convergence for improved Quality of service (QoS) and Quality of Experience (QoE).

### BACKGROUND

Wireless communication transfers information between multiple points without using an electrical conductor as a medium for the transfer. Wireless communication may be implemented using different technologies or protocols, such as 5G, Wi-Fi, etc.

Wi-Fi communication has been widely used to provide local network and internet access to devices within the Wi-Fi range of one or more routers. Given the high popularity of Wi-Fi, a Wi-Fi network may be congested with surrounding networks, such as another Wi-Fi network, a cellular communication network, etc., which may operate in close or similar frequency bands. Those surrounding networks may cause interference or disturbance for users served by the Wi-Fi network and thus impact user QoS. In addition, given that certain applications have high QoE requirements, users may need dedicated and predictable QoS for running those applications.

Accordingly, what is needed are systems, devices, and methods for QoS and QoE improvement when multiple wireless networks co-exist.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

Figure (“FIG.”) 1 depicts a block diagram for a wireless network convergence system, according to embodiments of the present disclosure.

FIG. 2 depicts a block diagram for a cognitive layer, according to embodiments of the present disclosure.

FIG. 3 depicts a process for QoS/QoE aware scheduling, according to embodiments of the present disclosure.

FIG. 4 depicts a schematic of a UE connecting to a radio unit across different wireless links, according to embodiments of the present disclosure.

FIG. 5 depicts a process for traffic redirection across different wireless links, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any examples are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” or “packet” shall not be interpreted as limiting embodiments of the present invention to 5G networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

With evolvement of wireless communication technology, most current user equipment, such as smartphones, may support both Wi-Fi and 4G/5G communication protocols. The convergence of both protocols at an access point may not be very common as different chipsets may be used. It is desirable for a processing chip to have a processing capability on the chip that supports both protocol stacks and enables QoS/QoE aware scheduling for improved system performance. Described hereinafter are system and method embodiments for System for and WLAN private network convergence for improved QoS and QoE.

FIG. 1 depicts a block diagram for a wireless network convergence system, according to embodiments of the present disclosure. A UE or a customer-premises equipment (CPE) 110 couples to a first wireless station 122 via a first wireless link 121 and to a cellular base station 124 via a second wireless link 123. The first wireless station 122 may be a Wi-Fi access point and the first wireless link 121 may be a Wi-Fi connection. The second wireless station 124 may be a 5G-NR base station, e.g., a gNodeB (gNB), and the second wireless link 123 may be a 5G NR cellular link. A cognitive layer 126 couples to both the first wireless station 122 and the second wireless station 124. The cognitive layer 126 senses signal conditions for the first and second wireless links, and learns user preference for traffic allocation between the first and second wireless links.

In one or more embodiments, the wireless network convergence system may comprise a protocol convertor 128 that couples to both the first wireless station 122 and the second wireless station 124 to redirect traffic, by IP packet conversions, to/from the UE between the first wireless station 122 and the second wireless station 124. Such a traffic redirection may involve re-splitting of 5G data into 5G data-plane data and 5G control-plane data. The protocol converter 128 may potentially separate and/or enhance control protocol(s) for a 5G data flow for traffic management in case the 5G data flow or part of the 5G data flow gets redirected to/from Wi-Fi. The protocol converter 128 may couple, via a cloud connection 130, to an internet service server 140 and a core network (CN) 150, e.g., a 5G CN, for communication. The wireless network convergence system may further comprise an internet service controller 130 that makes decisions on QoS and QoE aware allocation based at least on the cognitive layer input.

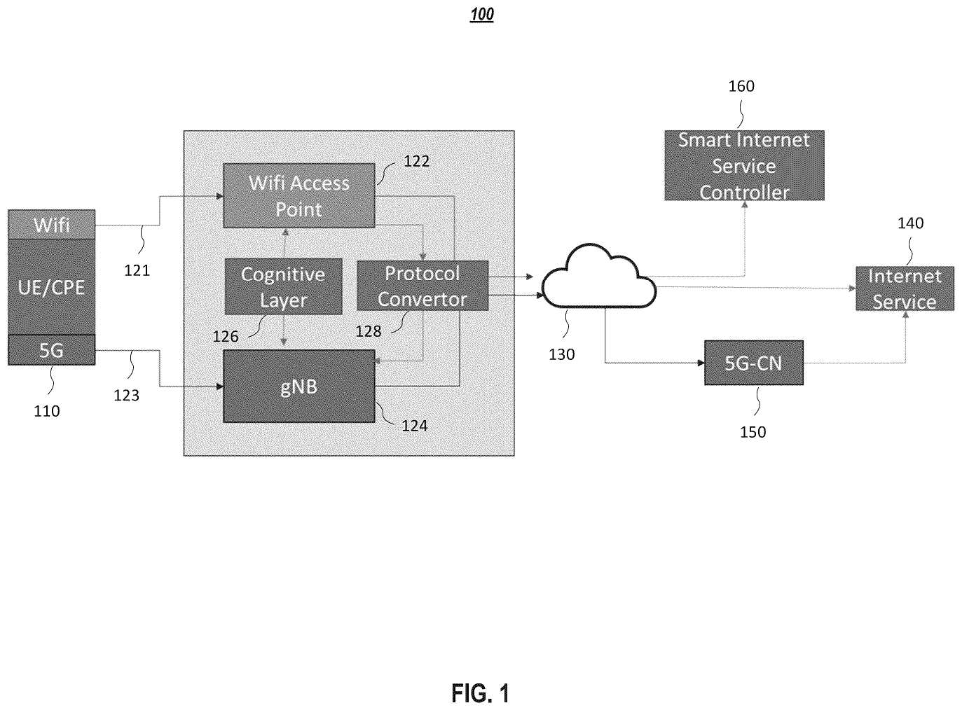

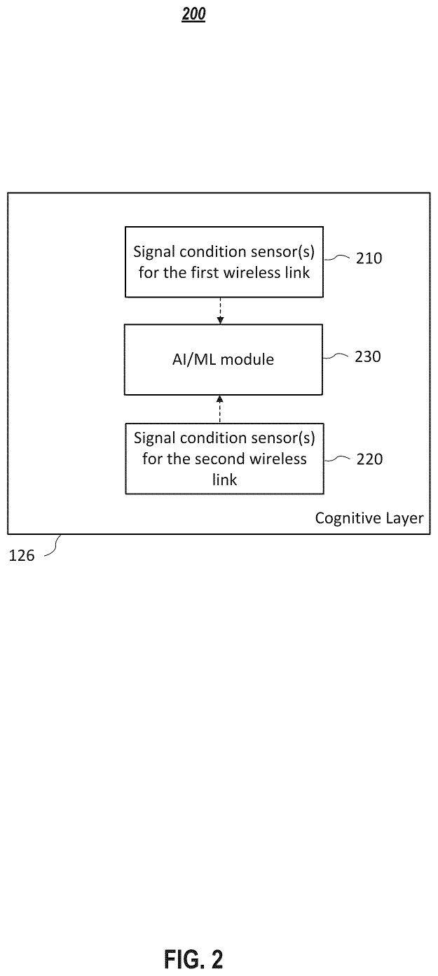

FIG. 2 depicts a block diagram for the cognitive layer, according to embodiments of the present disclosure. The cognitive layer 126 comprises one or more channel condition sensors 210 for the first wireless link, one or more channel condition sensors 220 for the second wireless link. The channel condition sensors are configured to determine one or more channel conditions for the first and the second wireless links based on one or more measurements. The channel condition may comprise one or more of: signal strength, signal-to-noise ratio (SNR), data ratio, throughput, current load information, signal (e.g., Wi-Fi) interference from the same channel used by adjacent APs, cellular interference from other macrocells or nearby small cells, traffic/channel congestion on each wireless link, error rates (e.g., hybrid automatic repeat request (HARQ) measurements), etc. The current load information may comprise size, data rate, band(s) and bandwidth(s) assigned for the current load, etc.

The cognitive layer 126 may comprise an operation module 230 to perform Artificial Intelligence (AI) or Machine Learning (ML)-based operation for QoS/QoE aware scheduling for at least one of the first wireless link 121 and the second wireless link 123. The cognitive layer 126 may be deployed in a single node (the first wireless station 122 or the second wireless station 124) or in two nodes with software/hardware acceleration. The QoS/QoE aware scheduling may be scheduling of downlink traffic or uplink traffic for the first wireless link 121 and/or the second wireless link 123. The QoS/QoE aware scheduling may be deployed for TDD/FDD in different bands and for simultaneous operations or alternative operations for the first wireless link 121 and/or the second wireless link 123. The cognitive layer 126 may further implement various forms of control, such as traffic management across Wi-Fi/5G, power control, modulation types, etc., for the QoS/QoE aware scheduling. These QoS/QoE aware scheduling and/or forms of control may be different for each user or client.

In one or more embodiments, the operation module 230 makes QoS/QoE aware scheduling based on channel conditions for the first and the second wireless links and historical data. The historical data may comprise user preferences for traffic allocation between available Wi-Fi and 5G networks, and historical traffic allocations for the UE and other UEs served by the first wireless station 122 and the second wireless station 124. The user preference may be a general preference or an application-specific preference. For example, a user may prefer Wi-Fi (e.g., IEEE 80211be) communication to meet QoS standards for applications that have high traffic and require low latency and high bandwidth. The historical data may be saved in a storage, e.g., a cloud database or an internal memory, accessible by the operation module 230.

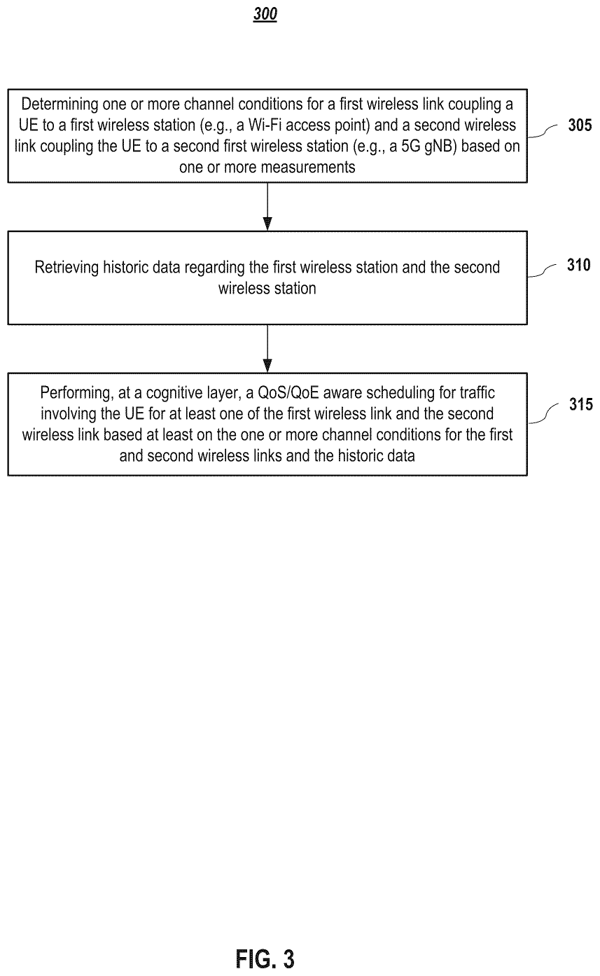

FIG. 3 depicts a process for QoS/QoE aware scheduling, according to embodiments of the present disclosure. In step 305, one or more channel conditions for a first wireless link coupling a UE to a first wireless station (e.g., a Wi-Fi access point) and a second wireless link coupling the UE to a second first wireless station (e.g., a 5G gNB) are determined based on one or more measurements. The first wireless station and the second wireless station may be separate devices or be integrated together as a single station capable of supporting both wireless links. The first wireless link is established using a first wireless technology (e.g., Wi-Fi) and the second wireless link is established using a second wireless technology (e.g., 5G NR) different from the first wireless technology.

In step 310, historical data regarding the first wireless station and the second wireless station are retrieved. The historical data may comprise user preference for traffic allocations between the first wireless station and the second first wireless station. The user preference may be a general preference or an application-specific preference.

In step 315, a QoS/QoE aware scheduling for traffic involving the UE is performed, at a cognitive layer, for at least one of the first wireless link and the second wireless link based at least on the one or more channel conditions for the first and second wireless links and the historical data. The traffic may be downlink traffic to the UE or uplink traffic from the UE. The QoS/QoE aware scheduling may be a scheduling for simultaneous operations or alternative operations for the first wireless link and the second wireless link. In one or more embodiments, the QoS/QoE aware scheduling is further based on load information for traffic to be scheduled, which may comprise load type (audio, video, streaming, text, etc.), size, data rate, latency requirement, band(s) and bandwidth(s) needed or preferred, etc.

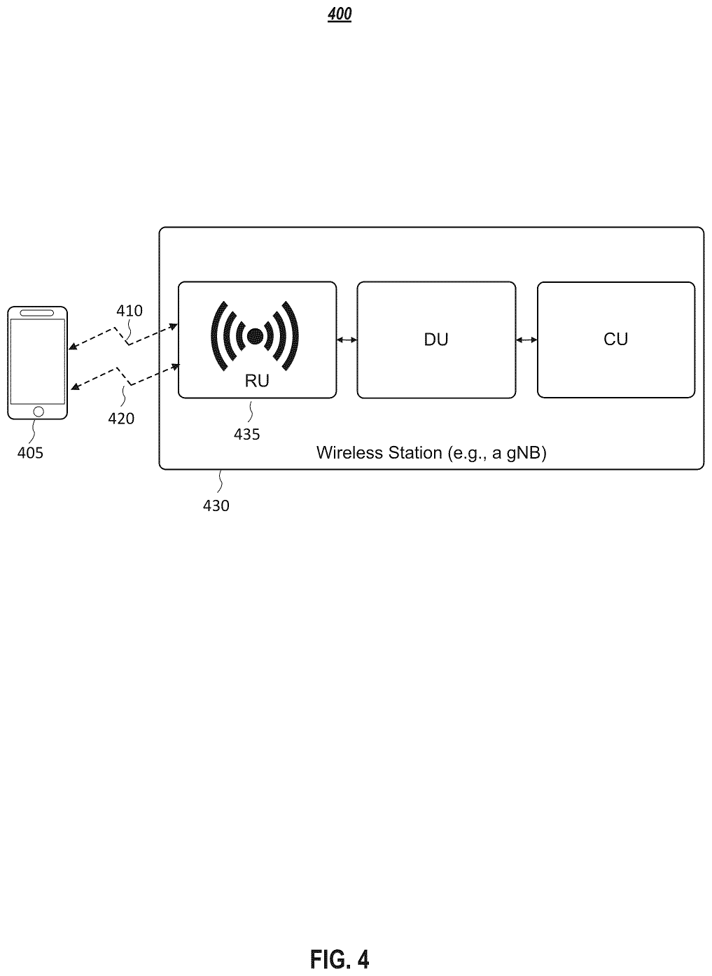

Currently, 5G-NR base stations (e.g., gNB) and Wi-Fi networks may be both deployed in the unlicensed 5G New Radio Unlicensed (NR-U) bands, leading to coexistence between two different wireless access technologies at the same or similar NR-U bands. FIG. 4 depicts a schematic of a UE connecting to a radio unit across different wireless links, according to embodiments of the present disclosure. A radio unit (RU) 435 in a wireless station 430, e.g., a small cell or a gNB, may couple to a UE 405 via a first wireless link 410, (e.g., a Wi-Fi link) and/or a second wireless link 420 (e.g., a cellular link) depending on the configuration of the RU and the capability of the UE. The wireless station 430 may comprise the RU, a distributed unit (DU), and a centralized unit (CU). The RU may comprise multiple antenna elements configurable to support signal receiving/transmission using the first wireless link, the second wireless link, or both.

In one or more embodiments, the QoS/QoE aware scheduling may comprise traffic redirecting, by a protocol converter, across the first wireless link and the second wireless link by IP packet conversion. Such a traffic redirection may involve re-splitting of 5G data into data-plane data and 5G control-plane data. For example, a protocol convertor may separate and/or enhance control protocol(s) for a 5G data flow in case the 5G data flow or part of the 5G data flow gets redirected to/from a Wi-Fi wireless link. Alternatively, to redirect a Wi-Fi data downlink flow, the traffic redirection may involve separate Wi-Fi data from Wi-Fi frames in the Wi-Fi data downlink flow and add 5G preambles to the Wi-Fi data to form a 5G downlink flow for transmitting to the UE. In one or more embodiments, the cognitive layer and the protocol converter may be integrated within the radio unit 430 of the wireless station 430.

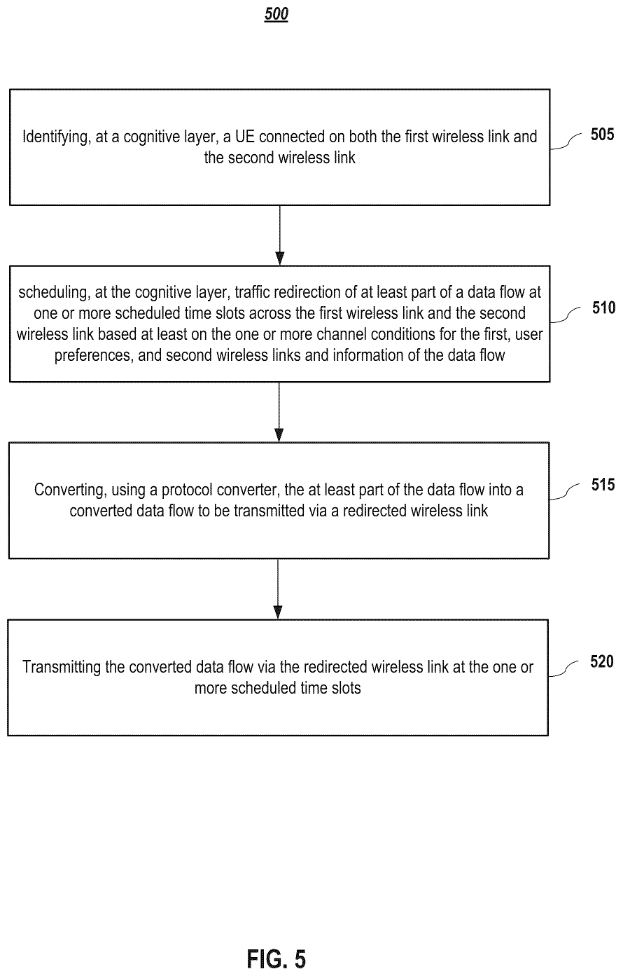

FIG. 5 depicts a process for traffic redirection across different wireless links, according to embodiments of the present disclosure. In step 505, the cognitive layer identifies a UE as connected on both the first wireless link and the second wireless link. In step 510, In step 510, traffic redirection of at least part of a data flow is scheduled, at the cognitive layer, at one or more scheduled time slots across the first wireless link and the second wireless link based at least on the one or more channel conditions for the first, user preferences, and second wireless links and information of the data flow. In one example, when a Wi-Fi access point is stressed with lots of traffic and thus has very limited bandwidth available for additional traffic while a 5G link is only lightly used with relatively high bandwidth available, the cognitive layer may schedule a traffic redirection for a downlink traffic of a video streaming initially scheduled to be transmitted via the Wi-Fi link such that at least part of the video streaming is redirected to be transmitted to the UE via a 5G link using a 5G NR-U band. In another example, a user is running an application (e.g., an online meeting) requiring low latency. Data flow for the application is initially transmitted via a Wi-Fi link. However, when the Wi-Fi link suffers some interference and has higher latency than expected, the cognitive layer senses the higher latency on the Wi-Fi link and may schedule a traffic redirection for data flows or part of the data flows for the application to be transmitted over a 5G link that has low latency currently.

In step 515, the protocol converter converts the at least part of the data flow into a converted data flow to be transmitted via a redirected wireless link, which may be the first wireless link or the second wireless link depending on the initial scheduled wireless link. Referring to the above example of video streaming, the protocol converter may convert part of the video streaming from a Wi-Fi protocol into a 5G protocol such that the converted part of video streaming can be transmitted via the 5G wireless link. In one or more embodiments, the protocol converter may separate original preambles (e.g., Wi-Fi preambles) from the at least part of the data flow and add alternative preambles (e.g., 5G preambles) needed for data transmission on the redirected wireless link. In case the original wireless link is a Wi-Fi link, and the redirected wireless link is a 5G NR link, the protocol converter may further add control plane data to the at least part of the data flow.

In step 520, the converted data flow is transmitted via the redirected wireless link at the one or more scheduled time slots. In case the data flow is partial redirected via the converted redirected wireless link, the receiving party (the UE for downlink data flow, or a wireless station for uplink data flow) may need to reassemble traffic received from the original wireless link and the redirected wireless link to recover a complete data flow. In the above example of video streaming downlink transmission, the UE may receive a first portion of the video streaming via a Wi-Fi link and a second portion of the video streaming via a 5G cellular link. The first portion and the second portion are then reassembled at the UE, e.g., by frame numbers in the video streaming, into complete streaming.

In one or more embodiments, the cognitive layer may be a separate entity and may be merged with the protocol convertor in a common core for internet service. Such a deployment is applicable considering that not all access points provide a converged solution. In some embodiments, the cognitive layer may be deployed to solve problems due to high congestion on Wi-Fi channels when the density of the Wi-Fi access points is high (e.g., multiple access points in malls/offices), but not all Wi-Fi access points have 5G cellular connection enabled. The 5G cellular connection may have higher coverage and may be used to redirect traffic or part of the traffic on Wi-Fi links by scheduling requests for those traffics to be transmitted on 5G channel(s). Such a traffic redirection may effectively unclog Wi-Fi congestion.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by one or more processing devices. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A method for wireless network convergence comprising:
determining one or more channel conditions for a first wireless link coupling a user equipment (UE) to a first wireless station and a second wireless link coupling the UE to a second first wireless station based on one or more measurements;
retrieving historical data regarding the first wireless station and the second wireless station; and
performing, at a cognitive layer, a quality of service (QoS) aware scheduling for traffic involving the UE for at least one of the first wireless link and the second wireless link based at least on the one or more channel conditions for the first and second wireless links and the historical data.

2. The method of claim 1 wherein the first wireless link is established using a first wireless technology and the second wireless link is established using a second wireless technology different from the first wireless technology.

3. The method of claim 2 wherein the first wireless link is a Wi-Fi link and the second wireless link is a 5G new radio (NR) link, the first wireless station is a Wi-Fi access point and the second wireless station is a 5G gNodeB (gNB).

4. The method of claim 1 wherein the one or more channel conditions for the first wireless link and the second wireless link comprising one or more of:
signal strength;
signal-to-noise ratio (SNR);
data ratio;
throughput;
current load information;
signal interference from the same channel used by adjacent wireless access points;
cellular interference from other macrocells or nearby small cells;
traffic or channel congestion on the first and the second wireless links; and
error rates.

5. The method of claim 1 wherein the historical data comprises historical user preferences for traffic allocation, historical traffic allocations for the UE and other UEs served by the first wireless station and the second wireless station.

6. The method of claim 1 wherein the first wireless station and the second wireless station are separate devices or are integrated together as a single wireless station capable of supporting both the first wireless link and the second wireless link.

7. The method of claim 1 wherein the QoS aware scheduling is further based on load information for the traffic to be scheduled, the load information comprises load type, size, data rate, latency requirement, bandwidth needed or preferred for traffic transmission.

8. The method of claim 1 further comprising:
converting, using a protocol converter, at least part of the traffic involving the UE into a converted data flow to be transmitted via a redirected wireless link, the redirected wireless link is different from an initial wireless link initially scheduled for traffic transmission, the redirected wireless link and the initial wireless link are from the first wireless link and the second wireless link; and
transmitting the converted data flow via the redirected wireless link at one or more scheduled time slots.

9. The method of claim 8 wherein converting the at least part of the traffic involving the UE comprising:
separating original preambles from the at least part of the traffic; and
adding alternative preambles needed for data transmission on the redirected wireless link.

10. A method for wireless network convergence comprising:
identifying, at a cognitive layer, a user equipment (UE) connected on both the first wireless link to a first wireless station and a second wireless link to a second wireless station;
scheduling, at the cognitive layer, traffic redirection of at least part of a data flow at one or more scheduled time slots across the first wireless link and the second wireless link based at least on the one or more channel conditions for the first, user preferences, and second wireless links and information of the data flow, the data flow is scheduled to be transmitted or being transmitted on an initial wireless link that is one of the first and the second wireless links;
converting, using a protocol converter converts, the at least part of the data flow into a converted data flow to be transmitted via a redirected wireless link that is one of the first and the second wireless links and is different from the initial wireless link; and
transmitting the converted data flow via the redirected wireless link at the one or more scheduled time slots.

11. The method of claim 10 wherein the first wireless link is a Wi-Fi link and the second wireless link is a 5G new radio (NR) link, the first wireless station is a Wi-Fi access point and the second wireless station is a 5G gNodeB (gNB).

12. The method of claim 10 wherein the first wireless link is a first Wi-Fi link and the second wireless link is a second Wi-Fi link at a different band from the first Wi-Fi link.

13. The method of claim 10 wherein data flow is a downlink data flow or an uplink data flow, the information of the data flow comprises load type, size, data rate, latency requirement, bandwidth needed or preferred.

14. The method of claim 10 wherein converting the at least part of the traffic involving the UE comprising:
separating original preambles from the at least part of the data flow; and
adding alternative preambles needed for data transmission on the redirected wireless link.

15. The method of claim 10 wherein converting the at least part of the traffic involving the UE comprising:
when the data flow is a 5G data flow scheduled to be transmitted or being transmitted, re-splitting at least part of the 5G data flow into 5G data-plane data and 5G control-plane data.

16. A non-transitory computer-readable medium or media comprising one or more sequences of instructions which, when executed by at least one processor, causes steps for wireless network convergence comprising:
determining one or more channel conditions for a first wireless link coupling a user equipment (UE) to a first wireless station and a second wireless link coupling the UE to a second first wireless station based on one or more measurements;
retrieving historical data regarding the first wireless station and the second wireless station; and
performing a quality of service (QoS) aware scheduling for traffic involving the UE for at least one of the first wireless link and the second wireless link based at least on the one or more channel conditions for the first and second wireless links, the historical data, and load information for the traffic to be scheduled.

17. The non-transitory computer-readable medium or media of claim 16 wherein the one or more channel conditions for the first wireless link and the second wireless link comprising one or more of:
signal strength;
signal-to-noise ratio (SNR);
data ratio;
throughput;
current load information;
signal interference from a same channel used by adjacent wireless access points;
cellular interference from other macro cells or nearby small cells;
traffic or channel congestion on the first and the second wireless links; and
error rates.

18. The non-transitory computer-readable medium or media of claim 16 wherein the historical data comprises historical user preferences for traffic allocation, historical traffic allocations for the UE and other UEs served by the first wireless station and the second wireless station.

19. The non-transitory computer-readable medium or media of claim 16 wherein the load information comprises load type, size, data rate, latency requirement, bandwidth needed or preferred for traffic transmission.

20. The non-transitory computer-readable medium or media of claim 15 further comprising one or more sequences of instructions which, when executed by at least one processor, causes steps to be performed comprising:
converting, using a protocol converter, at least part of the traffic involving the UE into a converted data flow to be transmitted via a redirected wireless link, the redirected wireless link is different from an initial wireless link initially scheduled for traffic transmission, the redirected wireless link and the initial wireless link are from the first wireless link and the second wireless link; and
transmitting the converted data flow via the redirected wireless link at one or more scheduled time slots.
